(19) United States
(12) Patent Application Publication
(10) Pub. No.: US 2006/0104580 A1
(43) Pub. Date: May 18, 2006

(54) Optical fiber cable

(75) Inventors: Eun-Song Um, Gumi-si (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co,; LTD

(21) Appl. No.: 11/209,887

(22) Filed: Aug. 23, 2005

(30) Foreign Application Priority Data
Nov. 15, 2004 (KR) 2004-92962

(51) Int. Cl. G02B 6/44

(52) U.S. Cl. 385/113; 385/100; 385/109; 385/110; 385/112

(57) ABSTRACT

An optical fiber cable includes a central tensile member aligned at a center of the optical fiber cable and extending along a longitudinal axis of the optical fiber cable, a plurality of loose tubes for receiving a plurality of optical fibers therein, an outer jacket surrounding the loose tubes so as to protect the loose tubes and the central tensile member from an external environment, and a waterproof tape aligned between the loose tubes and the outer jacket and in contact with a part of an inner peripheral surface of the outer jacket and extending along the longitudinal axis of the optical fiber cable.

### CLAIM OF PRIORITY

This application claims priority to an application entitled “Optical Fiber Cable”, filed with the Korean Intellectual Property Office on Nov. 15, 2004 and assigned Ser. No. 2004-92962, the entire contents of which are incorporated herein by reference.

### BACKGROUND OF THE INVENTION

1. Field of the Invention

The present invention relates to an optical fiber cable and more particularly, the present invention relates to an optical fiber cable including a waterproof tape.

2. Description of the Related Art

In general, an optical fiber cable is used for combining a plurality of optical fibers in such a manner that the optical fibers are protected from external environment while being easily installed and managed. This type of an optical fiber cable typically comprises a plurality of tensile members for reinforcing weak tensile force of the optical fiber and a plurality of waterproof members for preventing water from penetrating into the optical fiber.

FIG. 1 is a sectional view illustrating a conventional optical fiber cable. As shown, the conventional optical fiber cable includes a central tensile member 120, a plurality of loose tubes 110 aligned around the central tensile member 120, a waterproof tape 130 for binding the loose tubes 110 and the central tensile member 120, an outer jacket 140 for surrounding the waterproof tape 130, and a waterproof member 150.

The central tensile member 120 has a double-layered structure including a rod 122 made from FRP and a jacket 121 surrounding the rod 122. The waterproof member 150 is aligned between the central tensile member 120 and the loose tubes 110 in order to waterproof the optical fiber cable. The waterproof member 150 may be a waterproof yarn.

Each of the loose tubes 110 includes a plurality of optical fibers 112, a tube 111 for receiving the optical fibers 112 therein, and a filling member 113 formed between the tube 111 and the optical fibers 112 in order to dampen external impact applied to the loose tubes 110 while waterproofing the loose tubes 110.

The waterproof tape 130 is aligned between the outer jacket 140 and the loose tubes 110 and surrounds the loose tubes 110.

FIGS. 2 and 3 further illustrate loose tubes surrounded by the waterproof tape 130 as shown in FIG. 1. More specifically, FIG. 2 shows loose tubes 110a, which are wrapped by a waterproof tape 130a according to a spiral taping scheme in which the waterproof tape 130a spirally surrounds the loose tubes 110a lengthwise along a longitudinal axis of the loose tubes 110a. In this case, the overlapping sections 131a of the waterproof tape 130a are continuously formed along the loose tubes 110a, thus achieving a superior wet-proof characteristic without using an additional waterproof member.

FIG. 3 shows another loose tubes 110b aligned about a central tensile member 120b and enclosed by a waterproof tape 130b using a longitudinal taping scheme in such a manner that an overlapping section 131b can be formed on the waterproof tape 130b. According to the wrapping schemes, the overlapping sections are bonded by the waterproof tape.

The waterproof tape, as described above, typically has a thickness of about 0.2 to 0.3 mm which in turn causes the overlapping section to have a thickness of about 0.4 to 0.6 mm. Thus, the outer diameter of the optical fiber cable may be enlarged due to the waterproof tape. In addition, the outer diameter of the optical fiber cable may be irregularly formed along a longitudinal axis of the optical fiber cable due to the overlapping sections of the waterproof tape. These characteristics are undesirable in the fabrication of an optical fiber cable.

### SUMMARY OF THE INVENTION

Accordingly, the present invention has been made to solve the above-mentioned problems occurring in the prior art and provides additional advantages, by providing an optical fiber cable capable of obtaining a waterproof characteristic without enlarging the outer diameter of the optical fiber cable and without being formed irregularly due to overlapping sections of a waterproof tape.

In one embodiment, there is provided an optical fiber cable comprising: a central tensile member aligned at a center of the optical fiber cable and extending along a longitudinal axis of the optical fiber cable; a plurality of loose tubes aligned around the central tensile member and receiving a plurality of optical fibers therein; an outer jacket surrounding the loose tubes so as to protect the loose tubes and the central tensile member from an external environment; and a waterproof tape aligned between the loose tubes and the outer jacket while making a contact with a portion of an inner peripheral surface of the outer jacket and extending along the longitudinal axis of the optical fiber cable.

### BRIEF DESCRIPTION OF THE DRAWINGS

The above features and advantages of the present invention will be more apparent from the following detailed description taken in conjunction with the accompanying drawings, in which:

FIG. 1 is a sectional view illustrating a conventional optical fiber cable;

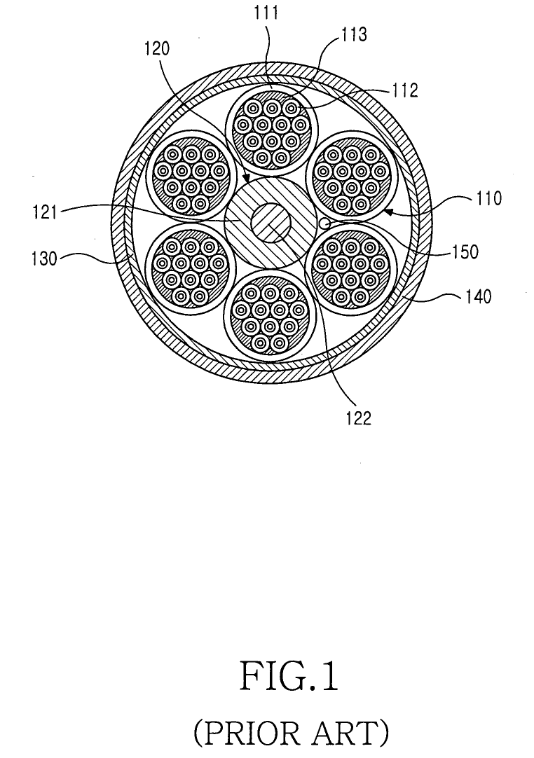

FIG. 2 is a perspective view illustrating the loose tubes of FIG. 1 enclosed by a waterproof tape through a spiral taping pattern;

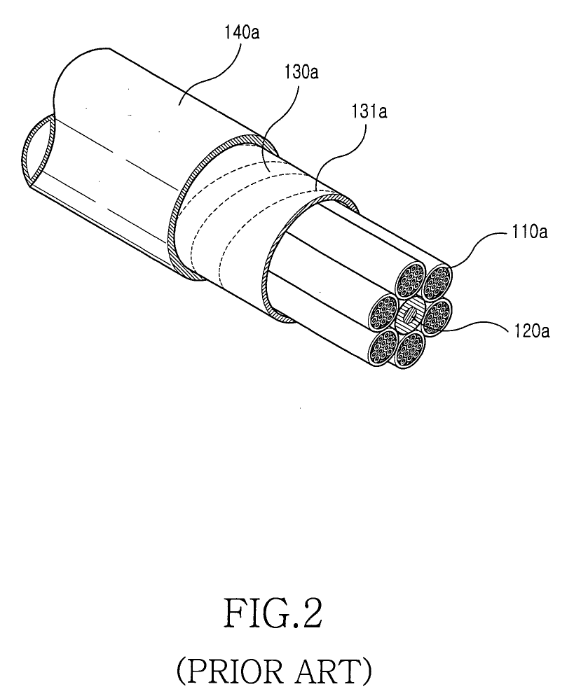

FIG. 3 is a perspective view illustrating loose tubes of FIG. 1 enclosed by a waterproof tape through a longitudinal taping scheme;

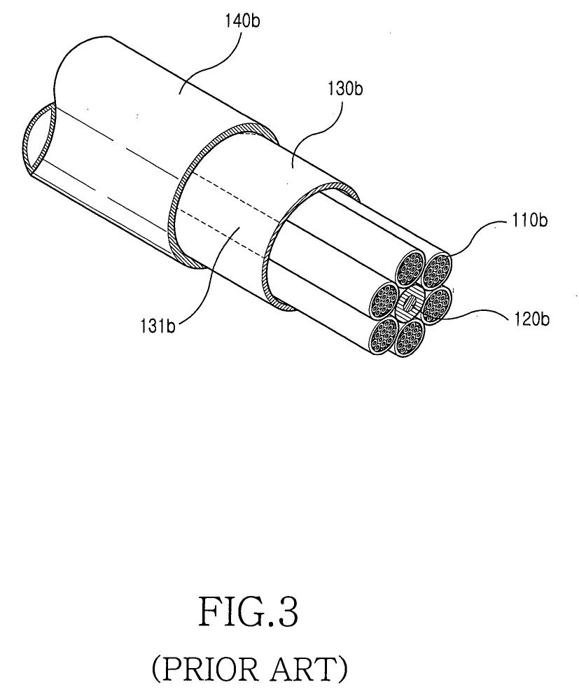

FIG. 4 is a sectional view illustrating a sectional structure of an optical fiber cable according to an embodiment of the present invention; and

FIG. 5 is a perspective view of an optical fiber cable shown in FIG. 4.

### DETAILED DESCRIPTION

Hereinafter, embodiments of the present invention will be described with reference to the accompanying drawings. For the purposes of clarity and simplicity, a detailed description of known functions and configurations incorporated herein will be omitted when it may make the subject matter of the present invention unclear.

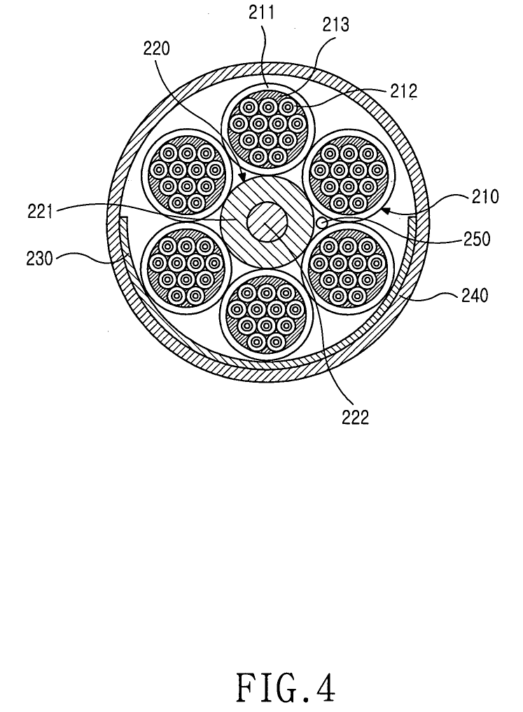

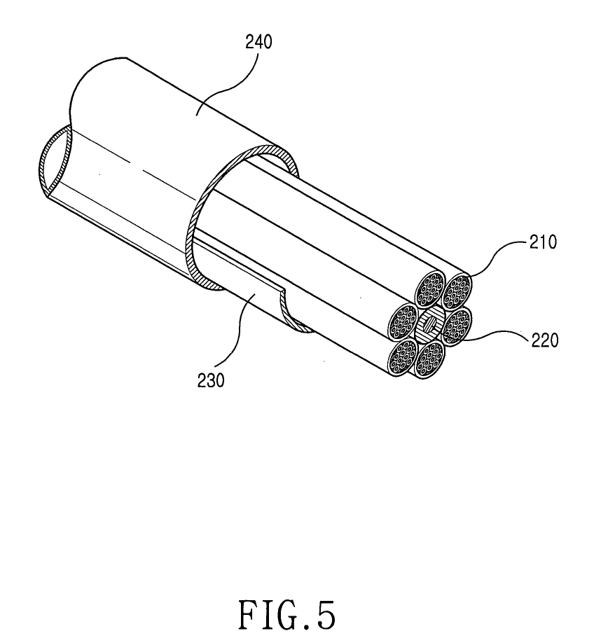

FIGS. 4 and 5 illustrate a structure of an optical fiber cable according to an embodiment of the present invention. Referring to FIGS. 4 and 5, the optical fiber cable according to the embodiment of the present invention includes a central tensile member 220 extending along a longitudinal axis of the optical fiber cable, a plurality of loose tubes 210 for receiving a plurality of optical fibers 212 therein, an outer jacket 240 for protecting the loose tubes 210 and the central tensile member 220, a waterproof tape 230 aligned between the loose tubes 210 and the outer jacket 240, and a waterproof member 250.

The central tensile member 220 is aligned at a center of the optical fiber cable and extends along the longitudinal axis of the optical fiber cable. The central tensile member 220 has a multi-layered structure including first and second layers 221 and 222, which are made from mutually different materials. For example, the central tensile member 220 may include an Fiberglass Reinforced Plastic (FRP) layer 222 and a plastic layer 221 surrounding the FRP layer 222.

The waterproof member 250 is provided in a cavity formed between the central tensile member 220 and the loose tubes 240. The waterproof member 250 may include a waterproof yarn or a waterproof tape.

Each of the loose tubes 210 includes a plurality of optical fibers 212, a tube 211 for binding the optical fibers 212, and a filling member formed between the tube 211 and the optical fibers 212. The loose tubes 210 are aligned around the central tensile member 220 in a spiral pattern or an S-Z pattern. In the embodiment, the optical tube 210 accommodated in the optical fiber cable may include a colored fiber, a buffered-optical fiber, or a ribbon optical fiber.

The outer jacket 240 surrounds the loose tubes 210 and serves to protect the loose tubes 210 and the central tensile member 220 from an external environment. The outer jacket 240 may be made from polymer plastic.

The waterproof tape 230 is in contact with a part of an inner peripheral surface of the outer jacket 240 and extends along the longitudinal axis of the optical fiber cable. The waterproof tape 230 is aligned and in contact with some of the loose tubes 210, thereby providing a water path introduced into the optical fiber cable. Here, the size of the waterproof tape 230 in contact with a cable core consisting of the central tensile member 220 and the loose tubes 210 will be referred to as a space factor. Preferably, the space factor of the waterproof tape 230 with respect to the cable core is in a range of about 46 to 50%. However, the space factor may vary depending on the state of the available optical fiber cable.

That is, the loose tubes 210, which are aligned in the S-Z pattern and the spiral pattern having a uniform pitch, are formed at the outer peripheral portions thereof with valley sections, the space between fiber tubes, so that water introduced into the optical fiber cable may flow along the valley sections. Accordingly, it is possible to obtain the waterproof characteristic even if the waterproof tape 230 is partially wrapped around the cable core. As the waterproof tape 230 wraps only some loose tubes 210 without wrapping the whole loose tubes 210, the overlapping sections are not required as in the prior art.

TABLE 1

| | | | Water leakage | Space |
|---|---|---|---|---|
| | Taping scheme | Width | length | factor |
| #1 | Longitudinal taping | 16 mm | 127 cm, 100.5 cm | 46.3% |
| | scheme of the | | | |
| | present invention | | | |
| #2 | Longitudinal taping | 20 mm | 93 cm, 59 cm | 57.9% |
| | scheme of the | | | |
| | present invention | | | |
| #3 | Conventional spiral | 16 mm | 60 cm, 50 cm | 100% |
| | taping scheme | | | |
| #4 | Waterproof yarn | 2500denir × 2ea | Water leakage | 0.5% |
| | longitudinal taping | | | |
| | scheme | | | |

Table 1 shows a test result when the conventional taping scheme and the taping scheme according to the present invention are applied to an optical fiber cable. The space factor shown in Table 1 signifies a size of the waterproof member wrapped around the loose tubes of the optical fiber cable. The waterproof test was performed according to IEC 6-794-1-2-F5B under the conditions of a water level (1 m) of a water tank, a length (3 m) of an optical fiber cable, and a test time (24 hours). Note that the waterproof test must satisfy the water leakage length less than 3 m.

Referring to Table 1, test #1 was performed by longitudinally wrapping an optical fiber cable using a waterproof tape having a width of 16 mm and measuring the water leakage of the optical fiber cable. Test #2 was performed by using a waterproof tape having a width of 20 mm with a space factor higher than that of test #1.

Test #3 was performed by spirally wrapping the optical fiber using a waterproof tape having a space factor of 100%, and test #4 was performed by using a waterproof yarn having a space factor of 0.5%, which indicates that only a small waterproof yarn is applied to the optical fiber cable within a limited range.

According to the test result, the teachings of the present invention obtained a waterproof characteristic even when the waterproof tape partially wraps the loose tubes without the need of spirally wrapping the whole loose tubes. Therefore, the waterproof tape in contact with a portion of an inner peripheral surface of the outer jacket and aligned along the longitudinal axis of the optical fiber cable prevents the outer diameter of the optical fiber cable from being enlarged and further prevents from being irregularly formed. Since loose tubes are aligned about the central tensile member with a uniform pitch or at a uniform interval, it is possible to obtain the superior waterproof characteristic even when the waterproof tape partially wraps the loose tubes.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical fiber cable comprising:
a central tensile member extending along a longitudinal axis of the optical fiber cable;
a plurality of loose tubes aligned around the central tensile member for receiving a plurality of optical fibers therein;
an outer jacket surrounding the loose tubes so as to protect the loose tubes and the central tensile member from an external environment; and
a waterproof tape aligned between the loose tubes and the outer jacket, the waterproof tape makes a contact with a part of an inner peripheral surface of the outer jacket and extends along the longitudinal axis of the optical fiber cable.

2. The optical fiber cable as claimed in claim 1, wherein each of the loose tubes further includes a tube for binding the optical fibers and a filling member formed between the optical fibers and the tube to prevent water from penetrating into the loose tube.

3. The optical fiber cable as claimed in claim 1, wherein the loose tubes are aligned around the central tensile member in a S-Z pattern.

4. The optical fiber cable as claimed in claim 2, wherein the filling member includes a tape having a waterproof function.

5. The optical fiber cable as claimed in claim 1, wherein the waterproof tape has a space factor substantially greater than 47% with respect to the inner peripheral surface of the outer jacket.

6. The optical fiber cable as claimed in claim 1, further comprising a waterproof member aligned in a cavity formed between the central tensile member and the loose tubes.

7. The optical fiber cable as claimed in claim 6, wherein the waterproof member includes a waterproof yarn.

8. The optical fiber cable as claimed in claim 6, wherein the waterproof member includes a waterproof tape.

9. The optical fiber cable as claimed in claim 1, wherein the water proof tape has a space factor with respect to the inner peripheral surface of the outer jacket in a range of 46 to 50%.

10. The optical fiber cable as claimed in claim 1, wherein the optical tube includes a colored fiber, a buffered-optical fiber, or a ribbon optical fiber.

11. The optical fiber cable as claimed in claim 1, wherein the outer jacket includes polymer plastic.

12. A method for providing an optical fiber cable having a central tensile member, a plurality of loose tubes for receiving a plurality of optical fibers therein, and an outer jacket surrounding the loose tubes, comprising providing a waterproof tape aligned between the loose tubes and the outer jacket, wherein the waterproof tape makes a contact with a portion of an inner peripheral surface of the outer jacket.

13. The method as claimed in claim 12, wherein the waterproof tape has a space factor substantially greater than 47% with respect to the inner peripheral surface of the outer jacket.

14. The method as claimed in claim 12, further providing a waterproof member aligned in a cavity formed between the central tensile member and the loose tubes.

15. The method as claimed in claim 14, wherein the waterproof member includes a waterproof yarn.

16. The method as claimed in claim 12, wherein the water proof tape has a space factor with respect to the inner peripheral surface of the outer jacket in a range of 46 to 50%.
